(19) United States
(12) Patent Application Publication
(10) Pub. No.: US 2022/0112993 A1
(43) Pub. Date: Apr. 14, 2022

(54) SOLAR SIMULATOR

(71) Applicant: Avalon ST Sàrl, Neuchâtel (CH)

(72) Inventor: Damien ETIENNE, Les Hauts-Geneveys (CH)

(21) Appl. No.: 17/268,890

(22) PCT Filed: Aug. 14, 2019
(86) PCT No.: PCT/IB2019/056890

§ 371 Date: Feb. 16, 2021

(30) Foreign Application Priority Data
Aug. 17, 2018 (CH) 01002/18

(51) Int. Cl. F21S 8/00; F21V 9/02; F21V 9/04

(52) U.S. Cl. CPC F21S 8/006; F21Y 2115/10; F21V 9/04; F21V 9/02

(57) ABSTRACT

A solar simulator has an array of light sources including LED light sources and at least one non-LED light source. At least a portion of the infrared-light wavelength range covered by the solar simulator is covered only by the non-LED light source More than 50% of the irradiance provided by the solar simulator is provided by the LED light sources. Application to artificially recreate sunlight in a solar testing device for the testing of solar cells, sun screens, and other products.

### FIELD OF THE INVENTION

The present invention concerns a solar simulator, i.e. a device that provides illumination through artificial light sources, thereby approximating natural sunlight. Such a solar simulator can be a solar testing device, and serves for instance as to provide a controllable indoor test facility under laboratory conditions, used for the testing of solar cells, sun screens, plastics, and other materials, devices and products.

### DESCRIPTION OF RELATED ART

Among solution to recreate artificially sunlight, Xenon light sources or other artificial light sources are largely used as the light source of a standard solar simulator. Among others a xenon arc lamp is quite expensive and provides a high flux which is not required for most applications. Mercury xenon lamps used to be another kind widely used light source in the early space solar simulators. However, mercury arc lamps have narrow bands of energy emission. US2006176694 presents a solution according to which the solar simulator combines mercury lamps and halogen lamps, some of the halogen lamps being provided further with a filter for limiting the amount of emitted infra-red light of these halogen lamps and mercury lamps to compensate the weak radiation of the halogen lamp in the shorter wavelengths (blue and UV portion). WO2012096565A1 presents a solar simulator comprising a high-intensity discharge (HID) lamp type and a halogen lamp type, which lamps are applied simultaneously and are provided with infrared filter means to provide a mixture of light approximating radiated sunlight.

Light-emitting diode lamp (LED) is a semiconductor light source based on the electroluminescence phenomenon, which emits a narrow-spectrum light when electrically biased in the forward direction of the p-n junction. The advantages of LEDs brought them to be recently the right source of light for solar simulators: among others, they have very long lifetime up to 50,000 to 100,000 hours, they can be controlled very fast within microseconds, they have a relatively narrow monochromatic output spectrum (except white LEDs) and are available in a wide variety of colors and wavelengths, which means combining a number of required colors LEDs can close-match application spectrum, and they are compact with low energy consumption.

For example, in CN105864718 is presented a LED solar simulator optical system using LEDs with various peak wavelengths within the wave band of 300-1100 nm. All LEDs with the same peak wavelength are integrated into a module with a lens. Also, in US2016238204 the LED-based simulator light source uses at least one diffractive element to spectrally combine the discreet spectral outputs of the individual LED groups to form a broad spectral output at the work surface. US2013021054A1 and DE102011002960B3 also propose solar simulators containing only LED light sources.

These and other LED based solar simulators provides simulators that needs to fulfil international standards relative to the solar simulator performance requirements, including IEC60904-9 Ed2 or Ed3 which specify how the spectrum of the solar simulator should extend up to 1200 nm. In that condition, providing a solar simulator with LEDs that can provide light for wavelengths above 1000 nm is not a reliable technology and is moreover very expensive. More specifically, above 1000 nm, the use of two LEDs is common, notably having their respective peak wavelength value at 1050 nm and 1200 nm, both of which are very expensive.

Also, there exists halogen based solar simulators, where LEDs are used to complete spectrum below ˜550 nm. However, they are prone to stability, heat and light source life time issues inerrant to the use of halogen providing more than 85% of the total irradiance of the solar simulator. Actually, it is important to have a relative stable temperature of the solar panel illuminated by the solar simulator in order to get a correct measurement of the performance of the solar panel. With halogen based solar simulators, the halogen lamp(s) take(s) time for the filament to heat-up and stabilize, about 1-3 seconds, so that the real irradiation time is up to a few seconds during which light is emitted which radiates the solar panel which produces heat. This radiation duration of the halogen lamp is therefore far longer than the measurement time which is only a few hundreds milliseconds (solar simulator usually use pulsed light or flash of about 10 milliseconds up to 500 milliseconds).

There is a need to provide solar simulators that can cover the solar spectrum including the wavelength range beyond 1000 nm and at least up to 1200 nm, which is less costly than the 100% LEDs solution.

This is also an aim of the present invention to provide a solution for a solar simulator that does not generate too much heat in the solar panel which is illuminated by the solar simulator, notably in the IR wavelength range.

This is also an aim of the present invention to provide an improved solar simulator that would overcome drawbacks of the existing and prior art solutions.

### BRIEF SUMMARY OF THE INVENTION

In one embodiment of the invention, these aims are achieved by means of a solar simulator comprising an array of light sources including LED light sources and at least one non-LED light source, wherein:

at least a portion of the infrared-light wavelength range covered by said solar simulator is covered only by said non-LED light source, and wherein

more than 50% of the irradiance provided by the solar simulator is provided by the LED light sources.

With such a solution, is provided a solar simulator that is less expensive since avoiding the use of only LED light sources for the infrared-light wavelength range. Also using non-LED light source(s) within at least a portion of the infrared-light wavelength range covered by said solar simulator provides a lower total irradiated power for the solar simulator, thereby less heat generated in the solar panel and thereby a lower need for cooling, which is less expensive and more reliable along the life time of the solar simulator.

In the present text, the words “irradiance” or “irradiation” correspond both to the same parameter which is the irradiated power by the light source to a target plane, which SI unit is W/m².

In one embodiment, more than 70% of the irradiance provided by the solar simulator is provided by the LED light sources. Also, in some embodiment, more than 80%, and possibly more than 90%, and eventually about 95% of the irradiance provided by the solar simulator is provided by the LED light sources.

In one embodiment, the solar simulator comprises further a filtering device placed above the non-LED light source with respect to the irradiation direction of the solar simulator, said filtering device reducing the total irradiance provided said by non-LED light source. With the use of such a filtering device, it is possible to keep within the wavelength range radiation emission spectrum of the solar simulator enough irradiance to match as close as possible the irradiance of sunlight and to eliminate extra irradiance, avoiding therefore too much heat generation in the solar panel or any other object illuminated by the solar simulator.

In one embodiment, said filtering device reduces the wavelength range radiation emission spectrum of the non-LED light source. With the use of such a filtering device, it is possible to keep within the wavelength range radiation emission spectrum of the solar simulator one wavelength sub-range (sub-interval) or several wavelength sub-ranges (sub-intervals) provided by the filtered light of the non-LED light source, while eliminating part of or totally one wavelength sub-range (sub-interval) or several wavelength sub-ranges (sub-intervals) provided by the non-filtered light of the non-LED light source. For instance the eliminated (filtered) wavelength sub-range(s) do not belong to the solar light spectrum or the eliminated (filtered) wavelength sub-range(s) belongs to the solar light spectrum but is (are) provided in a convenient way be the LED light sources.

In one embodiment, said filtering device comprises an optical high-pass filter or an optical band pass filter. As a possibility, the filtering device comprises only one optical high-pass filter or one optical band pass filter. As another possibility, said filtering device comprises one optical high-pass filter or one optical band pass filter, and another type of filter (one filter or several filters, said filters belonging to same type of filters or different type of filters).

In one embodiment, said portion of the infrared-light wavelength range covered only by said non-LED light source covers, namely overlap, at least the 1000-1200 nm wavelength range. As LED light sources having peak wavelength over 1000 nm, notably within the 1000-1200 nm wavelength range are expensive light sources, this allow to replace LED light sources for at least, including exactly, the 1000-1200 nm wavelength range by at least one non-LED light source.

In one embodiment, said non-LED light source is an halogen light source, said halogen light source being preferably a tungsten halogen lamp or comprising tungsten halogen lamps. Such an halogen light source provides a convenient complementary light source to the LED light sources, in particular when providing a limited irradiation, including but non-limited to wavelength range above 950, 1000 or 1050 nm.

In one embodiment, said solar simulator is a pulsed solar simulator. In a possible embodiment, the pulses of said solar simulator are equal or longer than 500 ms. In another embodiment, said simulator is a continuous solar simulator.

In one embodiment, in said solar simulator said filtering device reduces to less than 15% of the total irradiance the irradiance provided by said non-LED light source for wavelengths equal or lower than 750 nm, or for wavelengths equal or lower than 900 nm, or for wavelengths equal or lower than 1000 nm. Possibly, said filtering device reduces to less than 10%, or to 5% or to less than 5% the irradiance provided by said non-LED light source for wavelengths equal or lower than 750 nm, or for wavelengths equal or lower than 900 nm, or for wavelengths equal or lower than 1000 nm.

In one embodiment of said solar simulator, said filtering device reduces to less than 10% the irradiance provided by said non-LED light source for wavelengths equal or larger than 1200 nm, or for wavelengths equal or larger than 1250 nm, or for wavelengths equal or larger than 1300 nm. Possibly, said filtering device reduces to less than 5% the irradiance provided by said non-LED light source for wavelengths equal or larger than 1200 nm, or for wavelengths equal or larger than 1250 nm, or for wavelengths equal or larger than 1300 nm.

In one embodiment of said solar simulator, said portion covers a wavelength range including from 1100 nm onwards.

In one embodiment, said solar simulator has a light spectrum wherein the visible wavelength range is covered only by LED light sources.

In one embodiment of the solar simulator, less than 50% (possibly less than 30% or less than 20% of the total irradiance provided by said solar simulator is provided by said non-LED source

In one embodiment of the solar simulator, less than 10% of the total irradiance provided by said solar simulator is provided by said non-LED source. In parallel, in a possible embodiment, a maximum of about 10%, or preferably of about 5% of the total irradiance of the solar simulator is provided by said non-LED source.

In one embodiment, less than 20% of the irradiance provided by said solar simulator within the wavelength range between 300 to 1200 nm is provided by said non-LED light source.

In one embodiment of the solar simulator, less than 5% of the irradiance provided by said solar simulator within the wavelength range between 300 to 850 nm is provided by said non-LED light source.

In one embodiment, the irradiance provided for wavelengths larger than 1000 nm (or larger than 1050 nm) is provided for more than 50% by the non-LED light source.

In one embodiment of the solar simulator, the range of the wavelength spectrum of the solar simulator up to 800 nm is covered only by said LED light sources. According to a possibility, the range of the wavelength spectrum of the solar simulator up to at least 800 nm or also possibly up to at least 850 nm is covered only by said LED light sources.

In one embodiment of the solar simulator, the range of the wavelength spectrum of the solar simulator up to 800 nm is covered only by said LED light sources. In one embodiment, the range of the wavelength spectrum of the solar simulator up to 1000 nm is covered for the most part only by said LED light sources. In that situation, it can be that between 300 and 1000 nm, only a small range of the wavelength spectrum of the solar simulator uses LED light sources, for instance only above 800 nm or above 850 nm or above 900 nm. In one embodiment, in the range of the wavelength spectrum of the solar simulator up to 1000 nm, at each wavelength value the irradiance provided by the LED light sources is larger than the irradiance provided by the non-LED light source.

In one embodiment of the solar simulator, the range of the wavelength spectrum of the solar simulator up to 900 nm is covered only by said LED light sources. In one embodiment, the range of the wavelength spectrum of the solar simulator up to 1050 nm is covered for the most part only by said LED light sources.

In one embodiment of the solar simulator, at least one of said LED light sources has a peak wavelength equal or larger than 900 nm.

In one embodiment of the solar simulator, within the wavelength spectrum of the solar simulator, for the wavelength range up to 1000 nm, more than 50% of the total irradiance of the solar simulator is provided by the LED light sources. In one embodiment of the solar simulator, within the wavelength spectrum of the solar simulator, for the wavelength range up to 1000 nm, more than 60%, or possibly more than 70%, of the total irradiance of the solar simulator is provided by the LED light sources.

In one embodiment of the solar simulator, within the wavelength spectrum of the solar simulator, for the 1000 nm wavelength, more than 50% of the total irradiance of the solar simulator is provided by the LED light sources. In one embodiment of the solar simulator, within the wavelength spectrum of the solar simulator, for the 1000 nm wavelength, more than 60% (or possibly more than 70%) of the total irradiance of the solar simulator is provided by the LED light sources.

Further embodiments are described in the dependent claims and below.

### BRIEF DESCRIPTION OF THE DRAWINGS

The invention will be better understood with the aid of the description of embodiments given by way of example and illustrated by the figures, in which:

FIG. 1 shows a view in section of a first embodiment of the solar simulator according to the invention,

FIG. 2 shows a view in section of a second embodiment of the solar simulator according to the invention,

FIG. 3 shows a view in perspective of the second embodiment of the solar simulator according to the invention, from the emitting side of the panel covered by light sources

FIG. 4 shows a light spectrum obtained with a solar simulator according to the invention,

FIG. 5 shows an optical transmission curve for a possible filter used in combination with the non-LED light source, and

FIG. 6 shows an optical transmission curve for another possible filter arrangement used in combination with the non-LED light source.

### DETAILED DESCRIPTION OF POSSIBLE EMBODIMENTS OF THE INVENTION

According to the invention, the solar simulator 10 comprises an array of light sources including LED light sources and at least one non-LED light source.

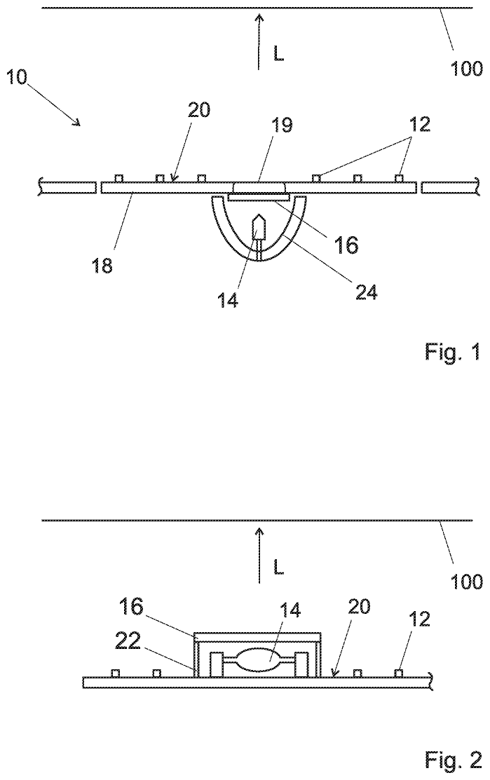

In some embodiments, said LED light sources 12 are distributed on an active face 20 of at least one plate 18 forming for instance a PCB, namely a Printed circuit board. In FIGS. 1 and 2 only one PCB plate 18 is shown but there could be two, three, or more (several or a plurality) plates 18. This plate 18 or these plates 18 as/are mounted on a structure to form a(n array of) plate(s) parallel to the target plan 100 to be illuminated. Also, these plates are shown to be flat and forming a plane but other geometrical configurations could be used for the plate(s) 18, including an curved 3D geometry, such as a portion of a sphere. In the case of planar plates 18 or PBC covered with LED light sources 12 on the active face 20, the direction of irradiation or direction of emission of light (arrow L in FIGS. 1 to 3) is orthogonal with respect to the plate(s) 18 and directed from the active face 20 towards the target plane 100. The target plan 100 to be illuminated is for instance formed by the outer face of a solar panel or a photovoltaic panel (not shown).

In a possible first embodiment shown in FIG. 1, said PCB plate 18 comprises further an opening 19, said non-LED light source 14 being placed behind said opening 19. In the example shown, this opening 19 could be circular or with another shape such as a square, a rectangle, an oval shape or another shape.

As a possibility, the non-LED light source 14 is an halogen light source, said halogen light source being possibly a tungsten halogen lamp or comprising tungsten halogen lamps. As an example, this halogen lamp has the following features:

A tungsten filament sealed in a transparent envelope that is filled with a mixture of inert gas and a small amount of halogen, with connection pins.

According to this first embodiment of FIG. 1, the solar simulator 10 further comprises a filtering device 16 formed by or comprising a filter. This filtering device 16 is used in combination with the non-LED light source 14. In a variant, this is an optical band pass filter, limiting more than 90% of the irradiance or even stopping 100% of the light for the wavelength at least between 1000 and 1200 nm, possibly between 900 and 1300 nm. As an example, this filter has the following features:

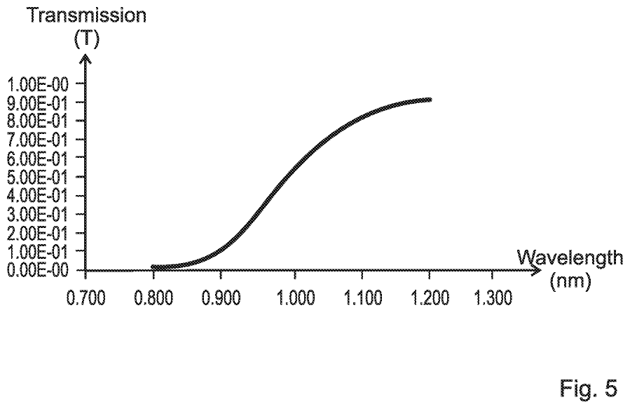

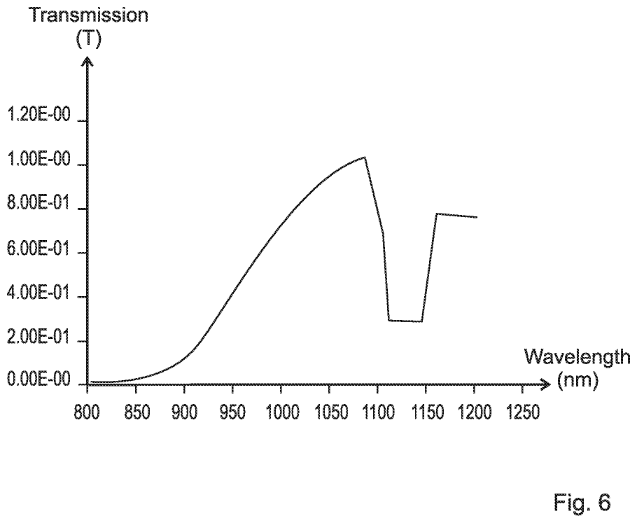

A transparent or semi-transparent or dyed substrate that selectively transmit or reflect wavelength(s) of interest. In a first example, the filter is a SCHOTT © RG1000 filter with the transmission curve shown in FIG. 5. In a second example, the filtering device 16 comprises the SCHOTT © RG1000 filter
in another variant, a band-stop filter is used in addition to the SCHOTT © RG1000 Filter to form a filtering device 16 which transmission curve is shown in FIG. 6.
in another variant not shown, the filtering device 16 comprises or is formed by a mirror which selectively reflects wavelength(s) of interest.
This filtering device 16 is placed upstream the non-LED light source 14 and covers a surface large enough to have the whole light beam of the non-LED light source 14 to pass through the filtering device 16. In FIG. 1 the filtering device 16 is placed on the opening 19 of the PCB plate 18, more precisely on the face of the PCB plate not covered by the LED light sources 12. In other possible (not shown) embodiments, the filtering device 16 is placed through the opening 19 of the PCB plate 18 or the filtering device 16 is placed on the opening 19 of the PCB plate 18 on the face of the PCB plate which is covered by the LED light sources 12.

In the present text, “upstream” and “downstream” refer to the direction of the light of the solar simulator 10, the L arrow showing the direction of irradiation of the solar simulator 10 in FIGS. 1 to 3 being orientated from upstream to downstream.

According to this first embodiment of FIG. 1, the solar simulator 10 further comprises a reflector 24 placed around and possibly upstream the non-LED light source 14. As can be seen in FIG. 1, this reflector 24 extends from behind the non-LED light source 14, with respect to the plate 18 (or with respect to the filtering device 16 if present), and around the non-LED light source 14 up to a location downstream the non-LED light source 14, notably up to the position of the filtering device 16 in case of presence of this filtering device, otherwise possibly up to the opening 19, otherwise possibly up to the rear face of the PCB plate 18 (face which is opposite to the active face 20).

This reflector 24 placed behind and around the non-LED light source 14 can reflect the portion of the light beam of the non-LED light source 14 which is not directed towards the opening 19, downstream, i.e. towards and through the opening 19. To that end, the reflector 24 has an internal surface with a high reflection coefficient and a low absorption coefficient, for instance a metallic internal surface forming thereby a mirror like surface.

As can be seen in FIG. 1, a possible shape for the reflector 24 is a shape of revolution around an axis coaxial with the main direction of the non-LED light source 14, with is limited by a curved line (generatrix). This possible shape is a corolla like shape or a cone, or a truncated cone with the larger diameter and aperture surrounding or facing the opening 20.

So, in the configuration of FIG. 1, from upstream to downstream, there is the reflector 24, the light emitting portion of the non-LED light source 14, the filtering device 16, the PCB plate(s) 18 and the light emitting portion of the LED light sources 12.

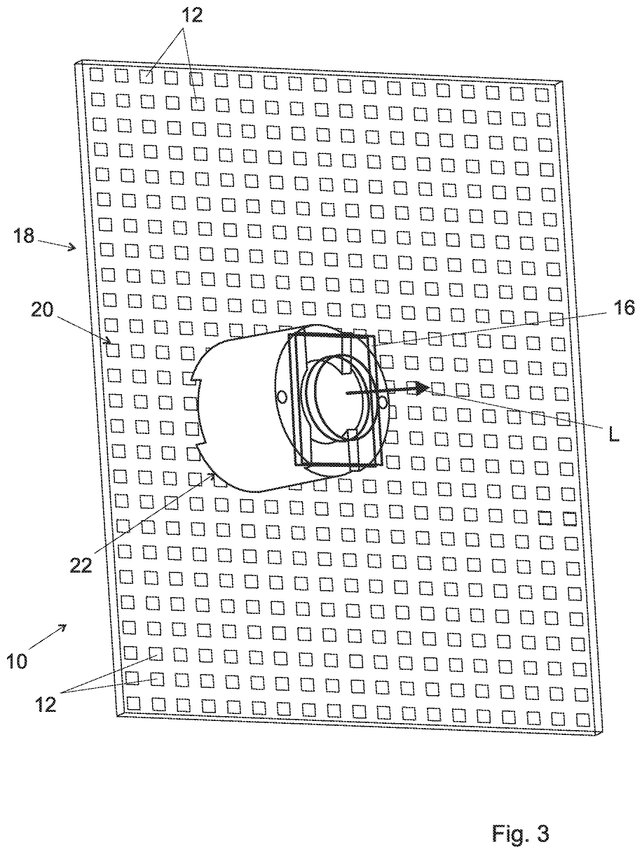

In a possible second embodiment shown in FIGS. 2 and 3, said non-LED light source 14 is placed on or above said active face 20 of the plate 18, within a lamp housing 22. This lamp housing 22 surrounds the non-LED light source 14. This lamp housing 22 forms a wall surrounding the non-LED light source 14 and focuses the light beam of the non-LED light source 14 towards the target plane 100, for instance this lamp housing 22 stops the external annular portion of the light beam of the non-LED light source 14.

According to this second embodiment of FIGS. 2 and 3, the solar simulator 10 further comprises a filtering device 16 as previously described. This filtering device 16 is possibly placed on the top (upstream side) of the lamp housing 22, forming thereby a closure of the lamp housing 22. This filtering device 16 is placed above the non-LED light source 14 in the irradiation direction L of the solar simulator 100.

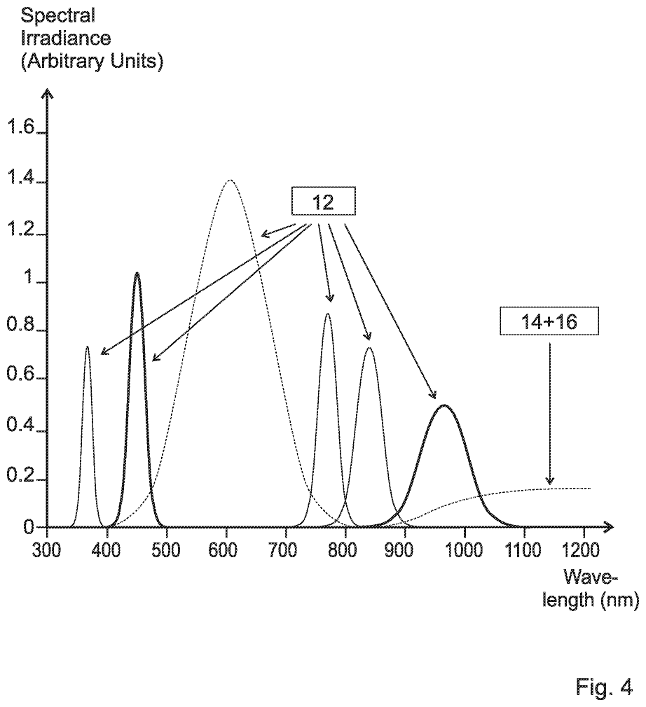

In an embodiment, as shown in FIG. 4 illustrating a possible light spectrum obtained with a solar simulator according to the invention (with six LED light sources 12 and one non-LED light source 14 associated with a filter), said LED light sources are divided into at least six different type of LEDS having different peak wavelength values. More precisely in FIG. 4, showing the light spectrum (spectral irradiance in arbitrary units—A.U.—that can be W.m⁻².nm⁻¹ in ordinate and wavelength in nanometers in abscissa), the solar simulator uses in this case exactly six different type of LEDS having different peak wavelength values, notably a peak wavelength value between 300 and 470 nm (for instance a peak wavelength value of 380 nm as shown in FIG. 4), a peak wavelength value between 470 and 561 nm (for instance a peak wavelength value of 450 nm as shown in FIG. 4), a peak wavelength value between 561 and 657 nm (for instance a peak wavelength value of 610 nm as shown in FIG. 4), a peak wavelength value between 657 and 772 nm (for instance a peak wavelength value of 750 nm as shown in FIG. 4), a peak wavelength value between 772 and 919 nm (for instance a peak wavelength value of 880 nm as shown in FIG. 4) and a peak wavelength value between 919 and 1200 nm (for instance a peak wavelength value of 980 nm as shown in FIG. 4).

More generally, said LED light sources 12 have peak wavelength values between 350 and 1000 nm, or said LED light sources 12 cover at least the wavelength range between 350 and 1000 nm.

In an embodiment, said LED light sources 12 are divided into at least ten different type of LED light sources 12 having different peak wavelength values, possibly nineteen different type of LED light sources 12.

In an embodiment, as shown in FIG. 4, said non-LED light source 14 has a light spectrum (which is illustrated after filtration through the filtering device 16) extending at least between 1000 nm and 1200 nm, and notably at least from 900 nm and 1200 nm.

Above 1200 nm, the spectrum of the solar simulator 10 can have several possible configurations, including no irradiance or low irradiance, but preferably has a spectral irradiance in line with or close to the spectral irradiance of the solar light spectrum.

To complete the solar simulator other conventional equipments can be used, among others possible equipments are as follows: a cooling system with air conditioner or any other type of cooling distribution, capacitor bank, electrical panels, computer, display, thermal chamber, temperature sensors, power supply, electronic load.

Also, in a possible embodiment, taken alone or in combination with the previously described embodiments or variants, the solar simulator further comprises a diffuser, notably an optical diffuser, which is placed on the light path to homogenize the angular response of the light sources.

Also, in a possible embodiment, taken alone or in combination with the previously described embodiments or variants, the solar simulator further comprises a reflector, notably an assembly optionally coated with reflective material, which is placed in regard of the light source in order to reorientate the maximum of the light emitted by the non-LED light source in the direction of the target plane.

Also, in a possible embodiment, taken alone or in combination with the previously described embodiments or variants, the solar simulator further comprises optical lens(es), notably fly-eye, convex or other type of lenses, which is (are) placed on the light path between the non-LED light source 14 or non-LED light sources

In the case of use of the combination of a reflector, diffusor and optical lens(es), this provides a solution to homogenize the angular irradiation of the non-LED light source(s) 14 and also to improve light uniformity on the target plane 100.

With the solar simulator of the present invention including a filtering device, the applicant performed to reduce about 8 times, from 80% to about 10%, the impact of the solar panel heating problem by filtering the light of the halogen light source.

The invention is not limited to the described embodiments, but could be realised within the scope of protection in any other way.

### REFERENCE NUMBERS USED ON THE FIGURES

10 Solar simulator
12 LED light sources
14 Non-LED light source
16 Filtering device
18 Plate (PCB)
19 Opening
20 Active face of the solar simulator
22 Lamp housing
24 Reflector
100 Target plane
L Direction of Irradiation, emission of Light

1. Solar simulator comprising an array of light sources including LED light sources and at least one non-LED light source, wherein:
at least a portion of the infrared-light wavelength range covered by said solar simulator is covered only by said non-LED light source, and wherein
more than 50% of the irradiance provided by the solar simulator is provided by the LED light sources.

2. Solar simulator according to claim 1, wherein said solar simulator comprises further a filtering device placed above the non-LED light source with respect to the irradiation direction of the solar simulator, said filtering device reducing the total irradiance provided said by non-LED light source.

3. Solar simulator according to claim 2, wherein said filtering device reduces the wavelength range radiation emission spectrum of the non-LED light source.

4. Solar simulator according to claim 2, wherein said filtering device reduces to less than 15% the irradiance provided by said non-LED light source for wavelengths equal or lower than 750 nm.

5. Solar simulator according to claim 2, wherein said filtering device reduces to less than 10% the irradiance provided by said non-LED light source for wavelengths equal or larger than 1200 nm.

6. Solar simulator according to 2, wherein said filtering device comprises an optical high-pass filter or an optical band pass filter.

7. Solar simulator according to claim 1, wherein said portion covers at least the 1000-1200 nm wavelength range.

8. Solar simulator according to claim 1, wherein said portion covers a wavelength range including from 1100 nm onwards.

9. Solar simulator according to claim 1, wherein the visible wavelength range is covered only by LED light sources.

10. Solar simulator according to claim 1, wherein less than 10% of the total irradiance provided by said solar simulator is provided by said non-LED source.

11. Solar simulator according to claim 1, wherein less than 20% of the irradiance provided by said solar simulator within the wavelength range between 300 to 1200 nm is provided by said non-LED light source.

12. Solar simulator according to claim 1, wherein less than 5% of the irradiance provided by said solar simulator within the wavelength range between 300 to 850 nm is provided by said non-LED light source.

13. Solar simulator according to claim 1, wherein the irradiance provided for wavelengths larger than 1000 nm is provided for more than 50% by the non-LED light source.

14. Solar simulator according to claim 1, wherein the range of the wavelength spectrum of the solar simulator up to 800 nm is covered only by said LED light sources.

15. Solar simulator according to claim 1, wherein the range of the wavelength spectrum of the solar simulator up to 1000 nm is covered only or for the most part by said LED light sources.

16. Solar simulator according to claim 1, wherein at least one of said LED light sources has a peak wavelength equal or larger than 900 nm.

17. Solar simulator according to claim 1, wherein within the wavelength spectrum of the solar simulator, for the wavelength range up to 1000 nm, more than 50% of the total irradiance of the solar simulator is provided by the LED light sources.

18. Solar simulators according to claim 1, wherein within the wavelength spectrum of the solar simulator, for the 1000 nm wavelength, more than 50% of the total irradiance of the solar simulator is provided by the LED light sources.

19. Solar simulator according to claim 1, wherein said non-LED light source is an halogen light source, said halogen light source being preferably a tungsten halogen lamp or comprising tungsten halogen lamps.

20. Solar simulator according to claim 1, wherein said simulator is a pulsed solar simulator.

21. Solar simulator according to claim 20, wherein the pulses are equal or longer than 500 ms.

22. Solar simulator according to claim 1, wherein said simulator is a continuous solar simulator.

23. Solar simulator according to claim 1, wherein said LED light sources are distributed on an active face of at least one PCB.

24. Solar simulator according to claim 1, wherein said LED light sources are divided into at least six different type of LEDS having different peak wavelength values.

25. Solar simulator according to claim 1, wherein said PCB comprises further an opening, said non-LED light source being placed behind said opening.

26. Solar simulator according to claim 23, wherein said non-LED light source is placed on or above said active face, within a lamp housing.
